(19) United States
(12) Patent Application Publication
(10) Pub. No.: US 2025/0004458 A1
(43) Pub. Date: Jan. 2, 2025

(54) SYSTEMS AND METHODS FOR IMPLEMENTING VARIABLE CYCLE TIMES FOR OVERALL EQUIPMENT EFFECTIVENESS ANALYTICS FOR INDUSTRIAL SYSTEMS

(71) Applicant: ROCKWELL AUTOMATION TECHNOLOGIES, INC., Mayfield Heights, OH (US)

(72) Inventors: Todd M. Smith, Chagrin Falls, OH (US); Matthew C. Giordano, Dublin, OH (US); Le Roy G. Howe, Hickory, NC (US)

(21) Appl. No.: 18/216,938

(22) Filed: Jun. 30, 2023

(51) Int. Cl. G05B 19/418; G05B 23/02

(52) U.S. Cl. CPC G05B 19/41875; G05B 23/0294; G05B 2219/32179

(57) ABSTRACT

Systems and methods for implementing variable cycle times for overall equipment effectiveness (OEE) analytics for industrial systems. The system may include an electronic processor configured to receive operational data describing a manufacturing process of an industrial system. The electronic processor may be configured to dynamically select, from a plurality of cycle times, a first cycle time for a first type of part manufactured by the industrial system as part of the manufacturing process and determine, using a first portion of the operational data associated with manufacturing the first type of part and the first cycle time, a first efficiency metric associated with manufacturing the first type of part. The electronic processor may be configured to determine, based on the first efficiency metric, an OEE of the industrial system. The electronic processor may be configured to generate and transmit a report indicating the OEE for display.

### SUMMARY

The following presents a simplified summary of the disclosed technology herein in order to provide a basic understanding of some aspects of the disclosed technology. This summary is not an extensive overview of the disclosed technology. It is intended neither to identify key or critical elements of the disclosed technology nor to delineate the scope of the disclosed technology. Its sole purpose is to present some concepts of the disclosed technology in a simplified form as a prelude to the more detailed description that is presented later.

The technology disclosed herein relates generally to industrial systems, and, more particularly, to manufacturing equipment and processes in industrial automation applications.

With regard to manufacturing equipment or processes, process indicators (e.g., cost per unit, time per unit, etc.) may be indicative of overall equipment effectiveness (“OEE”). OEE quantifies how well a manufacturing system performs relative to its designed capacity. For example, OEE may quantify availability, performance, and quality. Availability may represent a percentage of scheduled time (e.g., uptime) that an operation is available to operate. Performance may represent a speed at which a manufacturing equipment or process runs as a percentage of a designed speed of the manufacturing equipment or process. Quality may represent the good units produced as a percentage of the total units started.

While the traditional OEE quantifies availability, performance, and quality, other manufacturing metrics may further interpret the effectiveness of a manufacturing equipment or processes. For example, the traditional OEE as a time weighted average may be difficult to use and deliver accurate data. In particular, when applied to a machine that produces parts with differing ideal cycle times, the quality percentage of the traditional OEE is often inaccurate.

Such inaccuracies may be exposed when comparing a first OEE determination method and a second OEE determination method. With respect to the first OEE determination method, OEE may be determined as a result of dividing the product of Good Parts and Ideal Cycle Time by Available Time (i.e., OEE=(Good Parts*Ideal Cycle Time)/Available Time). With respect to the second OEE determination method, OEE may be determined as a result of multiplying the Availability percentage, the Performance percentage and the Quality percentage (i.e., OEE=Availability %*Performance %*Quality %), where the Availability percentage may be a result of dividing Running Time by Available Time (i.e., Availability %=Running Time/Available Time), the Performance percentage may be a result of dividing the product of Total and Ideal Cycle Time by the Running Time (i.e., Performance %=(Total Parts*Ideal Cycle Time)/Running Time), the Quality percentage may be a result of dividing the Good Parts and the Total Parts (i.e., Quality %=Good Parts/Total Parts), and Scrap Parts is the difference between Total Parts and Good Parts (i.e., Scrap Parts=Total Parts-Good Parts).

When Ideal Cycle Time is not constant, the first OEE determination method and the second OEE determination method may provide different results (i.e., different OEE results). The differing results may vary based on a variability of Ideal Cycle Time, a number of Scrap Parts, etc. While the Quality percentage determination (e.g., Quality %=Good Parts/Total Parts) may be commonly used for determining quality rates in multiple types of applications, the Quality percentage determination assumes that all parts being counted are the same. However, in a manufacturing environment, producing different parts may have different impacts on machine effectiveness, and producing Scrap Parts with different Ideal Cycle Times may cause different losses.

For instance, when calculating Quality rates on a machine in the context of measuring the effectiveness of that machine, the Ideal Cycle Time of each Scrap Part produced may be useful information. For example, a Scrap Part that takes two seconds of machine time to produce may represent four times the loss of production when compared to a Scrap Part that takes half a second of machine time to produce. However, the traditional Quality % determination treats each Scrap Part the same with no regard to its Ideal Cycle Time. Accordingly, while the traditional Quality % determination may produce an accurate result when all the Parts being considered have the same Ideal Cycle Time, the traditional Quality % determination will provide inaccurate (or incorrect) results when the Parts being considered have varying Ideal Cycle Times.

To solve these and other technical problems associated with traditional OEE determination methods, the technology disclosed herein modifies the traditional OEE determination methods to incorporate a production time for part(s), which may enable new types of applications. In some configurations, the technology disclosed herein implements an improved technical solution that takes into account the Ideal Cycle Times of the parts being produced and scrapped. For instance, the improved technical solution provided by the technology disclosed herein enables accurate OEE determinations, including instances where Ideal Cycle Times vary. In some configurations, the technology disclosed herein provides improved methods and systems of determining OEE for manufacturing equipment or processes with variable Ideal Cycle Times. In some configurations, the technology disclosed herein provides a method of determining OEE using an improved Quality metric or percentage determination that takes into consideration variable cycle times.

The technology disclosed herein provides systems and methods of implementing dynamic ideal cycle time for key performance indicators of industrial automation systems. One configuration provides a system for implementing variable cycle times for overall equipment effectiveness (OEE) analytics for industrial systems. The system may include one or more electronic processors. The one or more electronic processors may be configured to receive operational data describing a manufacturing process of an industrial system. The one or more electronic processors may be configured to dynamically select, from a plurality of cycle times, a first cycle time for a first type of part manufactured by the industrial system as part of the manufacturing process. The one or more electronic processors may be configured to determine, using a first portion of the operational data associated with manufacturing the first type of part and the first cycle time, a first efficiency metric associated with manufacturing the first type of part. The one or more electronic processors may be configured to determine, based on the first efficiency metric, an OEE of the industrial system associated with performance of the manufacturing process. The one or more electronic processors may be configured to generate and transmit a report for display, the report indicating the OEE of the industrial system.

Another configuration provides a method for implementing variable cycle times for overall equipment effectiveness (OEE) analytics for industrial systems. The method may include receiving, with one or more electronic processors, operational data describing a manufacturing process of an industrial system. The method may include dynamically selecting, with the one or more electronic processors, from a plurality of cycle times, a cycle time for a type of part manufactured by the industrial system as part of the manufacturing process. The method may include determining, with the one or more electronic processors, a first runtime for non-scrap parts of the type of part. The method may include determining, with the one or more electronic processors, a second runtime associated with manufacturing the type of part. The method may include determining, with the one or more electronic processors, a quality metric associated with manufacturing the type of part using at least a portion of the operational data associated with manufacturing the type of part, the cycle time, the first runtime, and the second runtime. The method may include determining, with the one or more electronic processors, an efficiency of the industrial system based at least in part on the quality metric. The method may include generating and transmitting, with the one or more electronic processors, an efficiency report for display, the efficiency report indicating the quality metric.

Yet another configuration provides a non-transitory, computer-readable medium storing instructions that, when executed by an electronic processor, perform a set of functions. The set of functions may include receiving operational data describing a manufacturing process of an industrial system. The set of functions may include dynamically selecting, from a plurality of cycle times, a first cycle time for a first type of part manufactured by the industrial system as part of the manufacturing process. The set of functions may include determining, using a first portion of the operational data associated with manufacturing the first type of part and the first cycle time, a first quality metric associated with manufacturing the first type of part. The set of functions may include dynamically selecting, from the plurality of cycle times, a second cycle time for a second type of part manufactured by the industrial system as part of the manufacturing process, wherein the second cycle time is different from the first cycle time. The set of functions may include determining, using a second portion of the operational data associated with manufacturing the second type of part and the second cycle time, a second quality metric associated with manufacturing the second type of part. The set of functions may include generating and transmitting a report to a display device for display, the report including the first quality metric and the second quality metric.

The foregoing and other aspects and advantages of the present disclosure will appear from the following description. In the description, reference is made to the accompanying drawings which form a part hereof, and in which there is shown by way of illustrations one or more embodiments of the present disclosure. Such configurations do not necessarily represent the full scope of the present disclosure, however, and reference is made therefore to the claims and herein for interpreting the scope of the present disclosure.

### BRIEF DESCRIPTION OF DRAWINGS

The present disclosure will be better understood and features, aspects and advantages other than those set forth above will become apparent when consideration is given to the following detailed description thereof. Such detailed description makes reference to the following drawings.

FIG. 1 schematically illustrates a system for implementing variable cycle times for overall equipment effectiveness (OEE) analytics for industrial systems according to some configurations.

FIG. 2 schematically illustrates a user device included in the system of FIG. 1 according to some configurations.

FIG. 3 is a flowchart illustrating a method for implementing variable cycle times for OEE analytics for industrial systems according to some configurations.

FIG. 4 is an example graphical user interface according to some configurations.

FIG. 5 is a table comparing quality metrics according to some configurations.

FIG. 6 illustrates an example analysis where the dataset has a single ideal cycle time according to some configurations.

FIG. 7 illustrates an example analysis where the dataset has multiple ideal cycle times according to some configurations.

### DETAILED DESCRIPTION

As utilized herein, terms “component,” “system,” “controller,” “device,” “manager,” and variants thereof are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The disclosed technology is described with reference to the drawings, wherein like reference numerals are used to refer to like elements throughout. In the following description, for purposes of explanation, numerous specific details are set forth in order to provide a thorough understanding of the disclosed technology. It may be evident, however, that the disclosed technology may be practiced without these specific details. In other instances, well-known structures and devices are shown in block diagram form in order to facilitate describing the disclosed technology.

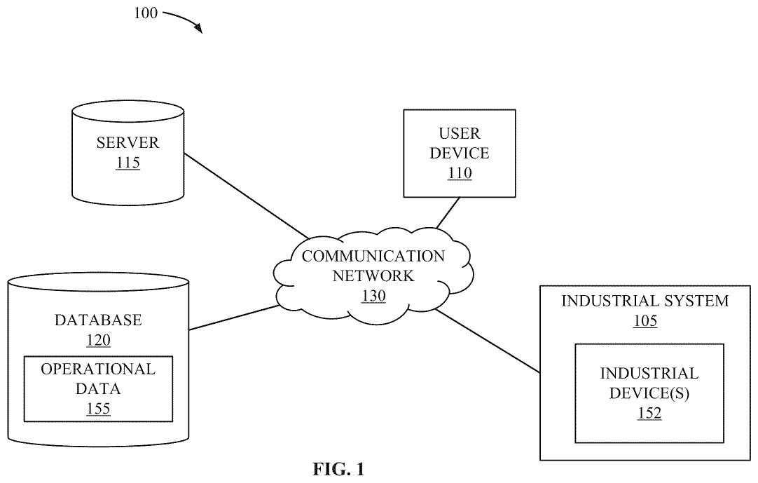

FIG. 1 schematically illustrates a system 100 for implementing variable cycle times for overall equipment effectiveness (OEE) monitoring and analytics for industrial systems according to some configurations. In the illustrated example, the system 100 may include an industrial system 105, a user device 110, a server 115, and a database 120. In some embodiments, the system 100 includes fewer, additional, or different components in different configurations than illustrated in FIG. 1. As one non-limiting example, the system 100 may include multiple industrial systems 105, multiple user devices 110, multiple servers 115, multiple databases 120, or a combination thereof. As another non-limiting example, one or more components of the system 100 may be combined into a single device, such as, e.g., the user device 110 and the server 115, the server 115 and the database 120, the user device 110, the server 115, and the database 120, etc. Alternatively, or in addition, in some configurations, the user device 110, the server 115, the database 120, or a combination thereof may be included as part of the industrial system 105 (e.g., as a component of the industrial system 105).

The industrial system 105, the user device 110, the server 115, the database 120 may communicate over one or more wired or wireless communication networks 130. Portions of the communication networks 130 may be implemented using a wide area network, such as the Internet, a local area network, such as BLUETOOTH® or WI-FI®, and combinations or derivatives thereof. Alternatively, or in addition, in some configurations, components of the system 100 may communicate directly as compared to through the communication network 130. Also, in some configurations, the components of the system 100 may communicate through one or more intermediary devices not illustrated in FIG. 1.

The industrial system 105 may be a manufacturing system, such as, e.g., an industrial automation system, a manufacturing or assembly line, or the like. The industrial system 105 may be associated with (or located at) a facility or site. In some configurations, a facility or site may be associated with multiple industrial systems 105 (e.g., a first industrial system, a second industrial system, a third industrial system, etc.). Accordingly, in some configurations, the industrial system 105 may be implemented at a facility. Alternatively, or in addition, in some configurations, the system 100 may include a first industrial system located at a first facility and a second industrial system located as a second facility different from the first facility. The industrial system 105 may be configured to perform one or more industrial processes, manufacturing processes, production processes, or the like. In some configurations, the industrial system 105 may perform a manufacturing or production method that produces goods or products. As one example, the industrial system 105 may perform a vehicle manufacturing processor to assemble or produce a vehicle (or various components thereof). As another example, the industrial system 105 may perform a food manufacturing process for making a food product. As yet another example, the industrial system 105 may perform a pharmaceutical manufacturing process for producing pharmaceuticals.

In the illustrated example, the industrial system 105 may include one or more industrial devices 152 (referred to herein collectively as “the industrial devices 152” and individually as “the industrial device 152”). The industrial device 152 may be a physical piece of manufacturing equipment included in the industrial system 105. For example, an industrial device 152 may include a pump, a press, a conveyor, a valve, an industrial controller (e.g., a programmable logic controller (“PLC”) and the like), a switch, a sensor, a server, a database, a human-machine interface (“HMI”), another piece of equipment that may be used in connection with an associated industrial process or application of the industrial system 105, or the like.

As illustrated in FIG. 1, in some configurations, the system 100 includes the database 120. The database 120 may store the operational data 155. The operational data 155 may include data or information describing operation of an industrial system or components thereof. For instance, the operational data 155 may include part identifiers (e.g., a set of part identifiers for parts involved in the manufacturing process or operation performed by the industrial system 105 (or industrial device(s) 152 thereof), run time data, available time data (e.g., an amount or duration of available time), total parts data (e.g., a total number of parts produced by the industrial system 105 (or industrial device(s) 152 thereof)), good parts (a count of good parts produced by the industrial system 105 (or the industrial device(s) 152 thereof)), other operation related data or information associated with a manufacturing process or operation performed by the industrial system 105 (or the industrial device(s) 152 thereof), etc.

The operational data 155 may be associated with (or originate from) one or more of the industrial devices 152 of the industrial system 105. For instance, the operational data 155 may include multiple sets of operational data (or operational datasets), where each set of operational data is associated with a particular industrial device of the industrial system 105. For example, the operational data 155 may include a first operational dataset associated with a first industrial device of the industrial system 105 and a second operational dataset associated with a second industrial device of the industrial system 105. In some configurations, the operational data 155 may be associated with (or originate from) one or more manufacturing cycles performed by the industrial system 105 (or the industrial device(s) 152 thereof). For example, the operational data 155 may include a first operational dataset associated with a first manufacturing cycle of a first industrial device and a second operational dataset associated with a second manufacturing cycle of the first industrial device. Alternatively, or in addition, in some configurations, the operational data 155 may include an operational dataset associated with the industrial system 105 (as a whole).

In some configurations, the database 120 may receive the operational data 155 from the industrial system 105 (or the industrial device(s) 152 thereof) via the communication network 130. The database 120 may receive the operational data 155 periodically. For example, the database 120 may receive the operational data 155 in accordance with a predetermined transmission schedule, such as, every day, every hour, after each manufacturing cycle is completed, etc. Alternatively, or in addition, the database 120 may receive the operational data 155 in response to a user request initiated via, e.g., the user device 110. Accordingly, in some configurations, the database 120 may receive the operational data 155 on-demand. Alternatively, or in addition, the database 120 may receive the operational data 155 continuously (e.g., in real-time or near real-time). For example, the database 120 may receive the operational data 155 in real-time (or near real-time) from the industrial system 105 (or the industrial device(s) 152 thereof) while the industrial system 105 (or the industrial device(s) 152 thereof) is performing a manufacturing process or operation. Accordingly, in some configurations, the operational data 155 is real-time (or near real-time) operational data describing a current or pending operation of a corresponding industrial system 105 (or the industrial device(s) 152 thereof).

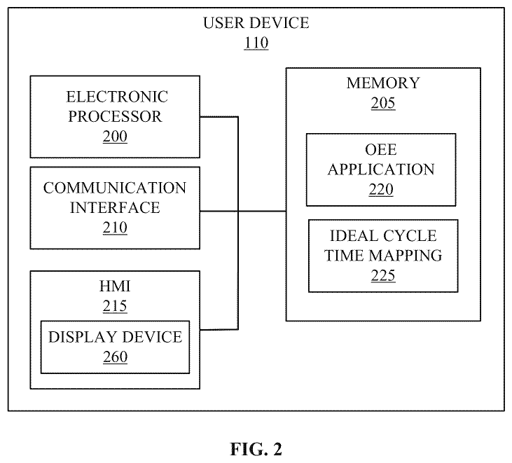

The user device 110 may be a computing device, such as a desktop computer, a laptop computer, a tablet computer, a terminal, a smart telephone, a smart television, a smart wearable, or another suitable computing device that interfaces with a user. As illustrated in FIG. 2, the user device 110 may include an electronic processor 200, a memory 205, a communication interface 210, and a human-machine interface (“HMI”) 215. The electronic processor 200, the memory 205, the communication interface 210, and the HMI 215 may communicate wirelessly, over one or more communication lines or buses, or a combination thereof. The user device 110 may include additional, fewer, or different components than those illustrated in FIG. 2 in various configurations. The user device 110 may also perform additional or different functionality other than the functionality described herein. Also, the functionality (or a portion thereof) described herein as being performed by the user device 110 may be distributed among multiple devices (e.g., as part of a cloud service or cloud-computing environment), combined with another component of the system 100 (e.g., combined with the server 115, the industrial system 105 (or a component thereof), the database 120, another component of the system 100, another remote device, or the like), or a combination thereof.

The communication interface 210 may include a transceiver that communicates with the industrial system 105, the server 115, or a combination thereof over the communication network 130 and, optionally, one or more other communication networks or connections. In some configurations, the communication interface 210 enables the user device 110 to communicate with the industrial system 105, the server 115, the database 120, or a combination thereof over one or more wired or wireless connections. The electronic processor 200 may include a microprocessor, an application-specific integrated circuit (“ASIC”), or another suitable electronic device for processing data, and the memory 205 includes a non-transitory, computer-readable storage medium. The electronic processor 200 is configured to retrieve instructions and data from the memory 205 and execute the instructions.

As one example, as illustrated in FIG. 2, the memory 205 may include an OEE application 220 (referred to herein as “the application 220”) and an ideal cycle time mapping 225. Although FIG. 2 illustrates the application 220 an the ideal cycle time mapping 225 as being stored in the memory 205, in some configurations, the application 220, the ideal cycle time mapping 225, or a combination thereof may be stored external to the memory 205, such as in one or more remote devices (e.g., the server 115).

The ideal cycle time mapping 225 may describe relationships between different part and cycle times (e.g., ideal cycle times). An ideal cycle time generally refers to an expected (or ideal) amount or duration of time for producing or manufacturing a part (e.g., an expected amount of machine time to produce the part). As noted herein, different parts may have different ideal cycle times. For instance, a first part may have a first cycle time while a second part may have a second cycle time different from the first cycle time. For example, a first part may take two seconds of machine time to produce while a second part may take five seconds of machine time to produce. In some configurations, different parts may have the same (or substantially similar) ideal cycle times. For example, a first part may take two seconds of machine time to produce, a second part may also take two seconds of machine time to produce, and a third part may take five seconds of machine time to produce. The ideal cycle time mapping 225 may map (or associate) a part with a corresponding ideal cycle time. In some configurations, the ideal cycle time mapping 225 may be a look up table associating a part with a corresponding ideal cycle time.

The application 220 may be a software application executable by the electronic processor 200 in the example illustrated and as specifically discussed below, although a similarly purposed module may be implemented in other ways in other examples. The electronic processor 200 may execute the application 220 to perform OEE monitoring and analytics associated with the industrial system 105 (or industrial device(s) 152 thereof). In some configurations, the electronic processor 200 may execute the application 220 to determine one or more efficiency metrics associated with a manufacturing operation or process performed by the industrial system 105 (or industrial device(s) 152 thereof) by dynamically varying an ideal cycle time based on a part (or part type) subject to the manufacturing operation or process, as described in greater detail herein. In some configurations, the electronic processor 200 may access or utilize the ideal cycle time mapping 225 as part of performing the OEE monitoring and analytics. Alternatively, or in addition, in some configurations, the electronic processor 200 may access or receive the operational data 155 from the database 120 as part of performing the OEE monitoring and analytics. As noted herein, in some configurations, the operational data 155 may be stored by another device other than (or in addition to) the database 120. Accordingly, in some configurations, the operational data 155 (or a portion thereof) may be stored in the memory 205 of the user device 110.

In some configurations, the electronic processor 200 may execute the application 220 to determine an efficiency classification for the industrial system 105 (or industrial device(s) 152 thereof). The efficiency classification may represent the OEE of the industrial system 105 (or industrial device(s) 152 thereof). An efficiency classification may be represented as an efficiency percentage (e.g., 90.5% efficient, 89% efficient, etc.) associated with the industrial system 105 as a whole (or one or more industrial devices 152 thereof). Alternatively, or in addition, in some configurations, the efficiency classification may be represented as an efficiency status or level, such as, e.g., inefficient, efficient, moderately efficient, etc. In such configurations, the electronic processor 200 may implement one or more thresholds or ranges for determining the efficiency status for the industrial system 105.

In some configurations, the application 220 may be a web-browser application that enables access and interaction with a OEE monitoring and analytics environment, such as, e.g., an OEE monitoring and analytics environment associated with the server 115 (e.g., where the OEE monitoring and analytics environment is a web-based service). Alternatively, or in addition, the application 220 may be a dedicated software application that enables access and interaction with an OEE monitoring and analytics environment, such as, e.g., an OEE monitoring and analytics environment associated with (or hosted by) the server 115. Accordingly, in some configurations, the application 220 may function as a software application that enables access to an OEE monitoring and analytics environment or service provided by the server 115.

As illustrated in FIG. 2, the user device 110 may include the HMI 215 for interacting with a user. The HMI 215 may include one or more input devices, one or more output devices, or a combination thereof. Accordingly, in some configurations, the HMI 215 allows a user to interact with (e.g., provide input to and receive output from) the user device 110. For example, the HMI 215 may include a keyboard, a cursor-control device (e.g., a mouse), a touch screen, a scroll ball, a mechanical button, a display device (e.g., a liquid crystal display (“LCD”)), a printer, a speaker, a microphone, another type of input device, another type of output device, or a combination thereof. As illustrated in FIG. 2, in some configurations, the HMI 215 includes a display device 260. The display device 260 may be included in the same housing as the user device 110 or may communicate with the user device 110 over one or more wired or wireless connections. For example, in some configurations, the display device 260 is a touchscreen included in a laptop computer or a tablet computer. In other configurations, the display device 260 is a monitor, a television, or a projector coupled to a terminal, desktop computer, or the like via one or more cables.

Returning to FIG. 1, the system 100 may also include the server 115. The server 115 may be a computing device. The server 115 may host or otherwise provide at least one OEE monitoring and analytics platform or environment. Accordingly, in some configurations, the server 115 is associated with an OEE monitoring and analytics platform (e.g., included as a component, device, or subsystem of a system providing or hosting an OEE monitoring and analytics platform or service). Alternatively, or in addition, in some configurations, the functionality (or a portion thereof) described herein as being performed by the user device 110 may be locally performed by the server 115. For example, in some configurations, the server 115 may store the application 220, the operation data 155 of the database 120, the ideal cycle time mapping 225, or a combination thereof. Although not illustrated in FIG. 1, the server 115 may include similar components as the user device 110, such as electronic processor (for example, a microprocessor, an ASIC, or another suitable electronic device), a memory (for example, a non-transitory, computer-readable storage medium), a communication interface, such as a transceiver, for communicating over the communication network 130 and, optionally, one or more additional communication networks or connections, and one or more HMIs.

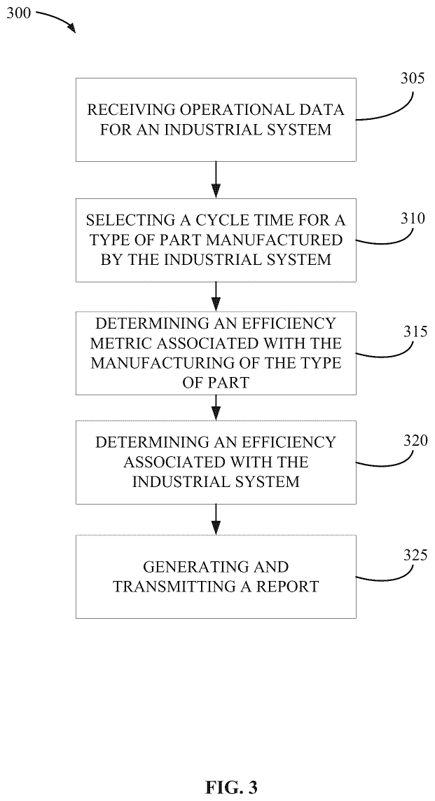

FIG. 3 is a flowchart illustrating a method 300 of implementing variable cycle times for (OEE) monitoring and analytics for the industrial system 105 (or one or more industrial devices 152 therein) according to some configurations. The method 300 is described as being performed by the user device 110 and, in particular, the electronic processor 200. However, as noted herein, the functionality described with respect to the method 300 may be performed by other devices, such as the server 115, a component included in the industrial system 105, or a combination thereof, distributed among a plurality of devices, such as a plurality of servers included in a cloud service, or a combination thereof.

As illustrated in FIG. 3, the method 300 may include receiving (or accessing), with the electronic processor 200, the operational data 155 for the industrial system 105 (at block 305). The electronic processor 200 may receive (or access) the operational data 155 from the database 120. Alternatively, or in addition, in some configurations, the operational data 155 (or a portion thereof) may be stored by a different device or component, such as, e.g., the memory 205 of the user device 110. In such configurations, the electronic processor 200 may receive (or access) the operational data 155 from the memory 205 of the user device 110. As described herein, the operational data 155 may include data or information describing operation of the industrial system 105 or components thereof (e.g., a manufacturing operation or process performed by the industrial system 105). For instance, the operational data 155 may include part identifiers (e.g., a set of part identifiers for parts involved in the manufacturing process or operation performed by the industrial system 105 (or industrial device(s) 152 thereof), run time data, available time data (e.g., an amount or duration of available time), total parts data (e.g., a total number of parts produced by the industrial system 105 (or industrial device(s) 152 thereof)), good parts (a count of good parts produced by the industrial system 105 (or the industrial device(s) 152 thereof)), other operation related data or information associated with a manufacturing process or operation performed by the industrial system 105 (or the industrial device(s) 152 thereof), etc.

The electronic processor 200 may select a cycle time for a part (or type of part) manufactured by the industrial system 105 (at block 310). In some configurations, the electronic processor 200 may dynamically select a cycle time for a type of part manufactured by the industrial system 105. As noted herein, different parts (or types of parts) may have different cycle times (e.g., ideal cycle times). For instance, a first part may have a first cycle time while a second part may have a second cycle time different from the first cycle time.

Accordingly, the electronic processor 200 may identify or determine a part (or type of part) associated with the operational data 155 (or a portion thereof) and select the cycle time for that part (or type of part). In some configurations, the electronic processor 200 may utilize the ideal cycle time mapping 225 to select the cycle time for a part (or part type). For instance, the electronic processor 200 may determine a type of part associated with a portion of the operational data 155. The electronic processor 200 may access the ideal cycle time mapping 225 to determine which cycle time (from a plurality of cycle times included in the ideal cycle time mapping 225) is mapped to or associated with the type of part. The electronic processor 200 may select the cycle time that is mapped to (or otherwise associated with) the type of part.

In some configurations, the electronic processor 200 may partition the operational data 155 into different data segments based on part (or part type). For example, the electronic processor 200 may identify a first data segment of the operational data 155 as pertaining to the manufacturing of a first part (or part type) and may identify another data segment of the operational data 155 as pertaining to the manufacturing of a second part (or part type). The electronic processor 200 may determine which portions (or data segments) of the operational data 155 are associated with which part (or part type) based on part identifiers included in the operational data 155. For example, data included in the operational data 155 may be specifically associated with a particular part identifier (e.g., a part type identifier). Accordingly, in some configurations, the electronic processor 200 may partition or identify portions of the operational data 155 as pertaining to the manufacturing of a particular part (or part type) using the part identifiers. Accordingly, the operational data 155 may be associated with a single part (or part type) or may be associated with multiple parts (or part types).

The electronic processor 200 may determine an efficiency metric associated with manufacturing the part (or type of part) (at block 315). In some configurations, the electronic processor 200 may determine the efficiency metric using the operational data 155 (e.g., or portion thereof pertaining to manufacturing the part) and the cycle time (e.g., as selected at block 310). In some configurations, the efficiency metric may be a quality metric, such as, e.g., a quality indicator or quality percentage.

In some configurations, the electronic processor 200 may determine the efficiency metric (e.g., the quality metric) by determining a runtime associated with manufacturing a set of non-scrap (or good) parts (e.g., a Good Ideal Runtime), determining a runtime associated with manufacturing the first type of parts (e.g., a Total Ideal Runtime), and determining a runtime associated with manufacturing scrap (or bad) parts (e.g., a Scrap Ideal Runtime). The electronic processor 200 may determine the Good Ideal Runtime based on the selected cycle time (or Ideal Cycle Time) and the total number of non-scrap (or good) parts (e.g., Good Parts). Accordingly, in some configurations, the electronic processor 200 may determine a total number of non-scrap (or good) parts for a particular part (or type of parts). The electronic processor 200 may determine the Total Ideal Runtime based on the selected cycle time (or Ideal Cycle Time) and a total number of parts (e.g., Total Parts). In some configurations, the electronic processor 200 may determine a total number of parts for a particular part (or type of parts) (e.g., a total number of manufactured parts for a particular type of part). The electronic processor 200 may determine a Scrap Ideal Runtime based on the selected cycle time (or Ideal Cycle Time) and a total number of scrap parts (e.g., Scrap Parts). In some configurations, the electronic processor 200 may determine a total number of scrap (or bad) parts for a particular part (or type of parts).

Accordingly, in some configurations, the electronic processor 200 may determine the quality metric (e.g., the efficiency metric) using one or more of the following equations:

$$Quality = \frac{Good Ideal Runtime}{Total Ideal Runtime}$$

$$Good Ideal Runtime = Good Parts \times Ideal Cycl Time$$

$$Total Ideal Runtime = Total Parts \times Ideal Cycle Time$$

$$Scrap Ideal Runtime = Scrap Parts \times Ideal Cycle Time$$

$$Quality \% = \frac{( Total Parts \times Ideal Cycle Time ) - ( Scrap Parts \times Ideal Cycle Time )}{Total Parts \times Ideal Cycle Time}$$

In some configurations, the electronic processor 200 may repeat one or more of blocks 305-315. For instance, when the operational data 155 includes multiple different parts (or types of parts), the electronic processor 200 may repeat one or more of blocks 305-315 for each part (or type of parts). Accordingly, in some configurations, the electronic processor 200 may determine one or more efficiency metrics (e.g., one or more quality metrics), where each quality metric may be associated with a particular part (or part type). For example, the electronic processor 200 may determine a first quality metric (as an efficiency metric) for a first part type, a second quality metric (as an efficiency metric) for a second part type, and an nth quality metric (as an efficiency metric) for an nth part type. In some configurations, when the electronic processor 200 determines multiple quality metrics, the electronic processor 200 may determine an overall quality metric (or an aggregated quality or efficiency metric) based on each of the plurality of quality metrics. In some configurations, the electronic processor 200 may determine an overall quality metric (or an aggregated quality or efficiency metric) by determining an average of multiple quality metrics (e.g., an average of each quality metric determined for each product type).

In some configurations, the electronic processor 200 may determine additional efficiency metrics based on the operational data 155. For instance, the electronic processor 200 may determine a performance metric, an availability metric, etc. The electronic processor 200 may determine a performance metric, an availability metric, or a combination thereof for each type of part manufactured by the industrial system 105. For example, when the industrial system 105 manufactures two types of parts, the electronic processor 200 may determine two performance metrics (a first performance metric associated with the first type of part and a second performance metric associated with the second type of part), two availability metrics (a first availability metric associated with the first type of part and a second availability metric associated with the second type of part), or a combination thereof. Alternatively, or in addition, the electronic processor 200 may determine a performance metric, an availability metric, or a combination thereof for the industrial system 105 as a whole.

In some configurations, the electronic processor 200 may determine the performance metric and the availability metric using the following equations:

$$Performance Metric = \frac{Total Parts \times Ideal Cycle Time}{RunTime}$$

$$Availability Metric = \frac{RunTime}{Available Time}$$

In some configurations, the electronic processor 200 may determine an efficiency for the industrial system 105 (at block 320). The electronic processor 200 may determine the efficiency for the industrial system 105 using one or more of the quality metric(s), the performance metric(s), the availability metric(s), or a combination thereof. In some configurations, the efficiency may be an OEE for the industrial system 105. In some examples, the electronic processor 200 may determine the OEE using one or more of the following equations.

$$OEE = Availability \times Performance \times Quality$$

$$OEE = \frac{Good Parts \times Ideal Cycle Time}{Available Time}$$

As described in greater detail herein, both of the above OEE equations yield the same results due to the implementation or consideration of Ideal Cycle Time with respect to the efficiency metric (e.g., the quality metric). In other words, the technology disclosed herein provide a technical solution to the inaccuracies introduced by variable cycle times when traditional OEE determinations are used.

In some configurations, the electronic processor 200 may generate and transmit a report (at block 325). The report may include information associated with the OEE monitoring and analytics performed by the electronic processor 200. For instance, the report may include, e.g., the quality metric(s), the availability metric(s), the performance metric(s), the efficiency (e.g., OEE) of the industrial system 105, the operational data 155 (or a portion thereof), other information or data associated with the OEE monitoring and analytics performed by the electronic processor 200.

The electronic processor 200 may generate and transmit the report for display to a user, such as, e.g., an operator of the industrial system 105, a facility administrator or supervisor, another user or entity associated with the manufacturing operation or process performed by the industrial system 105. In some examples, the electronic processor 200 may display the report via the display device 260 of the user device 110. Alternatively, or in addition, in some configurations, the electronic processor 200 may generate and transmit the report to a remote device, such as, e.g., the server 115, the database 120 (for remote storage), another remote device or server, etc.

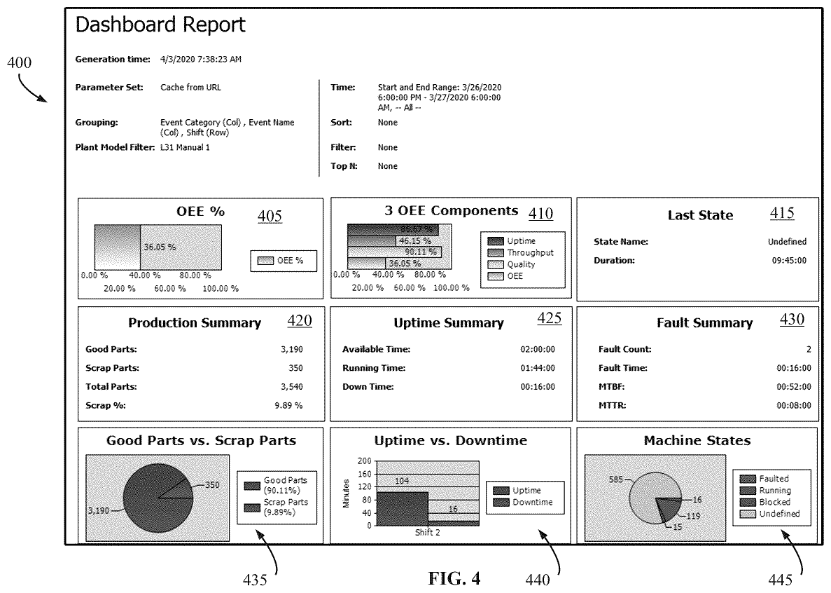

In some configurations, the electronic processor 200 may generate the report as a graphical user interface (GUI) for display to a user via, e.g., the display device 260 of the user device 110 such that a user may interact with the report (including the information included or provided therein). FIG. 4 illustrates an example GUIs according to some configurations. The example of FIG. 4 may be examples of the report.

For example, FIG. 4 illustrates a dashboard report 400 according to some configurations. As illustrated in FIG. 4, the dashboard report 400 may include an OEE percentage portion 405, an OEE component portion 410, and a last state portion 415. The OEE percentage portion 405 may include information relating to an OEE (e.g., an OEE of the industrial system 105). The OEE component portion 410 may include information relating to uptime, throughput, quality, and OEE for the industrial system 105. The last state portion 415 may include information associated with a last state of the industrial system 105, including, e.g., a state name, a duration, etc.

As illustrated in FIG. 4, the dashboard report 400 may include a production summary portion 420, an uptime summary portion 425, and a fault summary portion 430. The production summary portion 420 may include information associated with production for the industrial system 105, such as, e.g., a Good Parts count, a Scrap Parts count, a Total Parts count, a Scrap percentage, etc. The uptime summary portion 425 may include information associated with uptime for the industrial system 105, such as, e.g., available time, running time, down time, etc. The fault summary portion 430 may include information associated with faults for the industrial system 105, such as, e.g., a fault count, a fault time, a mean time between failure (“MTBF”), a mean time to repair (“MTTR”), etc.

The dashboard report 400 may provide information in graphical form (e.g., a bar graph, a pie graph, etc.). For instance, as illustrated in FIG. 4, the dashboard report 400 may include a graph 435 comparing good parts and scrap parts, a graph 440 comparing uptime and downtime of the industrial system 105, and a graph 445 comparing machine states (e.g., faulted, running, blocked, undefined, etc.).

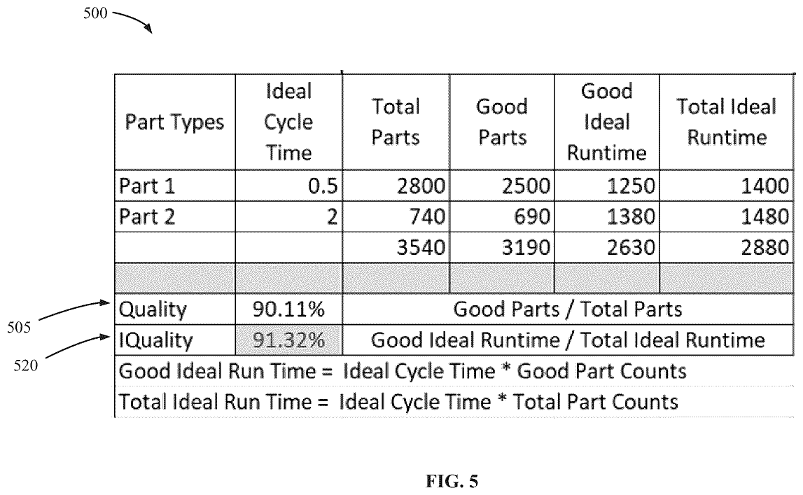

FIG. 5 illustrates a table 500 comparing a quality metric that does not consider variable cycle times for different parts (represented in FIG. 5 by reference numeral 505) and an improved quality metric that does consider variable cycle times for different parts (represented in FIG. 5 by reference numeral 520). As illustrated in FIG. 5, a first part (“Part 1” in FIG. 5) has an ideal cycle time of 0.5 seconds while a second part (“Part 2” in FIG. 5) has an ideal cycle time of 2 seconds. As illustrated in FIG. 5, the quality metric 505 is determined based on part counts alone (e.g., good parts divided by total parts). In contrast, the quality metric 520 considers time (e.g., good ideal runtime divided by total ideal runtime). By considering time, as opposed to part counts, an improved quality metric may be determined. In other words, as illustrated in the example of FIG. 5, the technology disclosed herein provides a technical solution that increases accuracy of OEE monitoring and analytics.

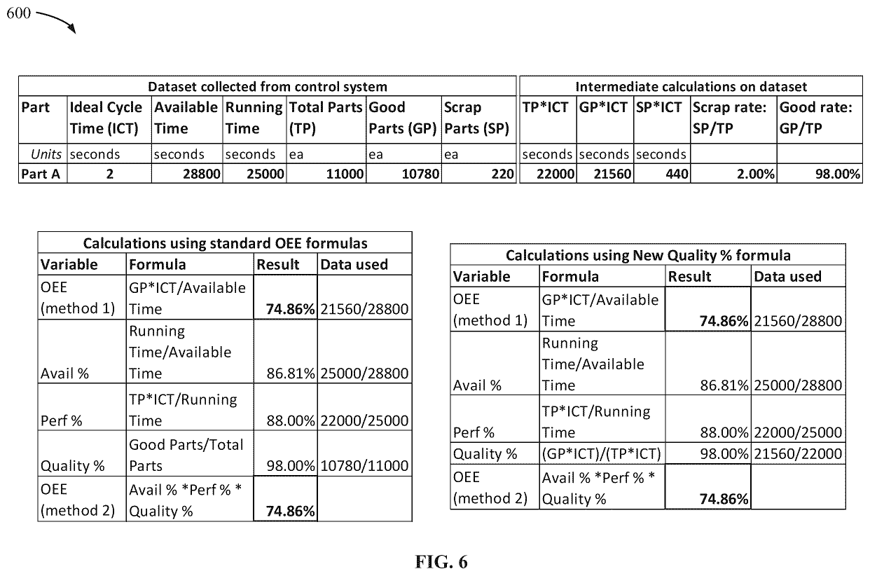

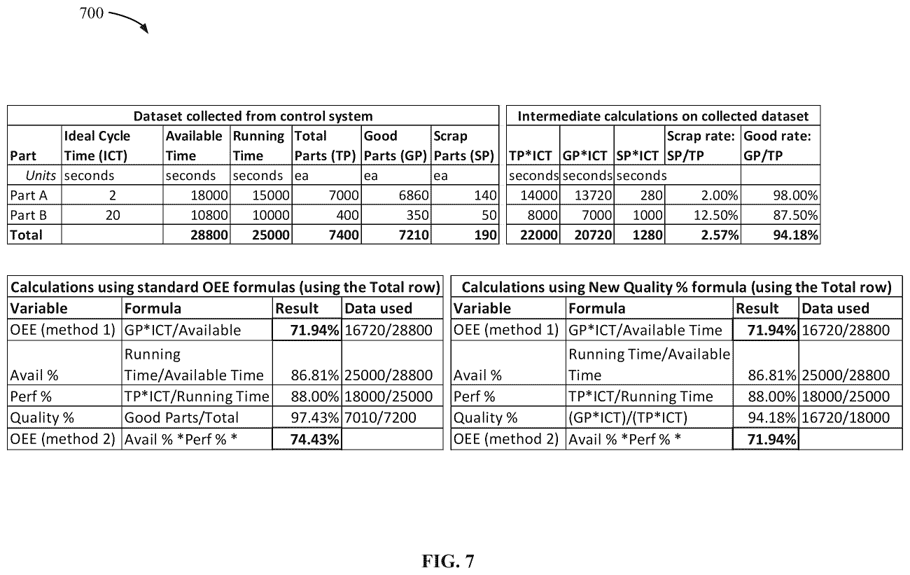

FIGS. 6-7 illustrate two dataset that further illustrate the technical solution (e.g., the increase in accuracy of OEE monitoring and analytics) as provided by the technology disclosed herein. FIG. 6 illustrates an example analysis 600 where the dataset has a single ideal cycle time according to some configurations. As illustrated in FIG. 6, traditional OEE formulas yield the same results for the two methods of computing OEE. The OEE formulas that include the improved quality metric (as described herein) also yield the same results for the two methods of computing OEE. Either set of formulas work when there is a single ideal cycle time in the dataset. FIG. 7 illustrates an example analysis 700 where the dataset has two different ideal cycle times according to some configurations. As illustrated in FIG. 7, the traditional OEE formulas yield different results for the two methods of computing OEE. As different results for the two methods are not allowed by the OEE standard, the traditional OEE formulas are incorrect (e.g., when the dataset includes different ideal cycle times). The OEE formulas that include the improved quality metric (as described herein) yield the same results for the two methods of computing OEE. Accordingly, the OEE formulas that include the improved quality metric (as described herein) are accurate (or correct).

What has been described above includes examples of the disclosed technology. It is, of course, not possible to describe every conceivable combination of components or methodologies for purposes of describing the disclosed technology, but one of ordinary skill in the art may recognize that many further combinations and permutations of the disclosed technology are possible. Accordingly, the disclosed technology is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed technology. In this regard, it will also be recognized that the disclosed technology includes a system as well as a computer-readable medium having computer-executable instructions for performing the acts and/or events of the various methods of the disclosed technology.

In addition, while a particular feature of the disclosed technology may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system for implementing variable cycle times for overall equipment effectiveness (OEE) analytics for industrial systems, the system comprising:
one or more electronic processors configured to:
receive operational data describing a manufacturing process of an industrial system;
dynamically select, from a plurality of cycle times, a first cycle time for a first type of part manufactured by the industrial system as part of the manufacturing process;
determine, using a first portion of the operational data associated with manufacturing the first type of part and the first cycle time, a first efficiency metric associated with manufacturing the first type of part;
determine, based on the first efficiency metric, an OEE of the industrial system associated with performance of the manufacturing process; and
generate and transmit a report for display, the report indicating the OEE of the industrial system.

2. The system of claim 1, wherein the one or more electronic processors are configured to:
select, from the plurality of cycle times, a second cycle time for a second type of part manufactured by the industrial system as part of the manufacturing process, wherein the second cycle time is different from the first cycle time; and
determine, using a second portion of the operational data associated with manufacturing the second type of part and the second cycle time, a second efficiency metric associated with manufacturing the second type of part.

3. The system of claim 2, wherein the one or more electronic processors are configured to determine the efficiency of the industrial system based on the first efficiency metric and the second efficiency metric.

4. The system of claim 1, wherein the first efficiency metric is a quality metric.

5. The system of claim 1, wherein the efficiency of the industrial system is an OEE percentage.

6. The system of claim 1, wherein the one or more electronic processors are configured to determine the first efficiency metric by
determining a first runtime associated with manufacturing a set of non-scrap parts of the first type of parts; and
determining a second runtime associated with manufacturing the first type of parts.

7. The system of claim 6, wherein the one or more electronic processors are configured to determine the first efficiency metric based on the first runtime, the second runtime, and the first cycle time.

8. The system of claim 6, wherein the one or more electronic processors are configured to determine the first runtime by determining a total number of non-scrap parts included in the set of non-scrap parts of the first type of parts, wherein the first runtime is determined based on the first cycle time and the total number of non-scrap parts included in the set of non-scrap parts.

9. The system of claim 6, wherein the one or more electronic processors are configured to determine the second runtime by determining a total number of the first type of parts, wherein the second runtime is determined based on the first cycle time and the total number of the first type of parts.

10. A method for implementing variable cycle times for overall equipment effectiveness (OEE) analytics for industrial systems, the method comprising:
receiving, with one or more electronic processors, operational data describing a manufacturing process of an industrial system;
dynamically selecting, with the one or more electronic processors, from a plurality of cycle times, a cycle time for a type of part manufactured by the industrial system as part of the manufacturing process;
determining, with the one or more electronic processors, a first runtime for non-scrap parts of the type of part;
determining, with the one or more electronic processors, a second runtime associated with manufacturing the type of part;
determining, with the one or more electronic processors, a quality metric associated with manufacturing the type of part using at least a portion of the operational data associated with manufacturing the type of part, the cycle time, the first runtime, and the second runtime;
determining, with the one or more electronic processors, an efficiency of the industrial system based at least in part on the quality metric; and
generating and transmitting, with the one or more electronic processors, an efficiency report for display, the efficiency report indicating the quality metric.

11. The method of claim 10, wherein determining the first runtime includes determining a total number of non-scrap parts for the type of part, wherein the first runtime is determined based on the cycle time and the total number of non-scrap parts.

12. The method of claim 10, wherein determining the second runtime includes determining a total number of parts manufactured for the type of part, wherein the second runtime is determined based on the cycle time and the total number of parts manufactured for the type of part.

13. The method of claim 10, wherein determining the quality metric includes determining a quality percentage.

14. The method of claim 10, wherein determining the efficiency of the industrial system includes
determining a performance metric based on a total number of parts manufactured for the type of part, a total runtime for the type of part, and the cycle time; and
determining an availability metric based on the total runtime for the type of part and an available time,
wherein the efficiency of the industrial system is based on the performance metric, the availability metric, and the quality metric.

15. A non-transitory, computer-readable medium storing instructions that, when executed by an electronic processor, perform a set of functions, the set of functions comprising:
receiving operational data describing a manufacturing process of an industrial system;
dynamically selecting, from a plurality of cycle times, a first cycle time for a first type of part manufactured by the industrial system as part of the manufacturing process;
determining, using a first portion of the operational data associated with manufacturing the first type of part and the first cycle time, a first quality metric associated with manufacturing the first type of part;
dynamically selecting, from the plurality of cycle times, a second cycle time for a second type of part manufactured by the industrial system as part of the manufacturing process, wherein the second cycle time is different from the first cycle time;
determining, using a second portion of the operational data associated with manufacturing the second type of part and the second cycle time, a second quality metric associated with manufacturing the second type of part;
generating and transmitting a report to a display device for display, the report including the first quality metric and the second quality metric.

16. The computer-readable medium of claim 15, the set of functions further comprising:
determining, based on the first quality metric and the second quality metric, an aggregated quality metric for the industrial system, wherein the report also includes the aggregated quality metric for the industrial system.

17. The computer-readable medium of claim 15, the set of functions further comprising:
determining, based at least in part on the first quality metric and the second quality metric, an OEE for the industrial system associated with performance of the manufacturing process, wherein the report also includes the OEE for the industrial system.

18. The computer-readable medium of claim 17, the set of functions further comprising:
dynamically selecting, from the plurality of cycle times, a third cycle time for a third type of part manufactured by the industrial system as part of the manufacturing process, wherein the third cycle time is different from the first cycle time and the second cycle time; and
determining, using a third portion of the operational data associated with manufacturing the third type of part and the third cycle time, a third quality metric associated with manufacturing the third type of part,
wherein the report also includes the third quality metric.

19. The computer-readable medium of claim 15, wherein determining the first quality metric includes
determining a first runtime associated with manufacturing a set of non-scrap parts of the first type of parts; and
determining a second runtime associated with manufacturing the first type of parts,
wherein the first quality metric is based on the first runtime, the second runtime, and the first cycle time.

20. The computer-readable medium of claim 19,
wherein determining the first runtime includes determining a total number of non-scrap parts included in the set of non-scrap parts of the first type of parts, wherein the first runtime is determined based on the first cycle time and the total number of non-scrap parts included in the set of non-scrap parts, and
wherein determining the second runtime includes determining a total number of the first type of parts, wherein the second runtime is determined based on the first cycle time and the total number of the first type of parts.
